(19) United States
(12) Patent Application Publication
(10) Pub. No.: US 2002/0167279 A1
(43) Pub. Date: Nov. 14, 2002

(54) Plasma screen of the surface discharge type

(76) Inventors: Markus Heinrich Klein, Heerlen (NL); Rob Snijkers, Heerlen (NL)

Correspondence Address: U.S. Philips Corporation, 580 White Plains Road, Tarrytown, NY, 10591, US

(21) Appl. No.: 10/122,793

(22) Filed: Apr. 12, 2002

(30) Foreign Application Priority Data
Apr. 14, 2001 (DE) 10118531.6

(51) Int. Cl. G09G 3/10

(52) U.S. Cl. 315/169.3

(57) ABSTRACT

The invention concerns a plasma screen of the surface discharge type in which the discharge electrodes are covered with a dielectric layer. Disadvantages of prior art plasma screens of the surface discharge type are the relatively high ignition voltage for the gas discharge and the low efficiency. In order to obtain a plasma screen of the surface discharge type with improved discharge efficiency, it its proposed that the capacitance of the dielectric layer C=f (layer thickness d, dielectric constant ε) is varied in a direction transversal to the discharge channel.

The invention concerns a plasma screen comprising a carrier plate, a transparent front plate, a ribbed structure that partitions the space between the carrier plate and the front plate into plasma cells that are filled with a gas, an electrode array of pairs of discharge electrodes that are arranged in pairs on both sides of a discharge path on the front plate, a dielectric layer that covers the electrode array on the front plate, and an electrode array of address electrodes on the carrier plate.

In a plasma screen of the surface discharge type, the light is generated by gas discharge in a three-electrode system. The three-electrode system comprises for each picture element one address electrode and two discharge electrodes, between which an alternating voltage is present during operation.

Plasma screens of this type of the prior art comprise a transparent front plate and a carrier plate that are maintained at a distance from one another and have a peripheral hermetic seal. The space between the two plates constitutes the discharge space, in which a gas filling is enclosed for the gas discharge. Individually controllable plasma cells are formed by a ribbed structure with separating ribs.

The inside of the front plate carries a number of pairs of elongated discharge electrodes that are arranged in pairs in parallel with each other. The discharge electrodes are covered by a layer of a dielectric material. The result is capacitors connected in series that comprise electrodes on the one side and the plasma and the dielectric layer on the other. The capacitance of the capacitors acts as a charge storage element between two alternating voltage pulses.

The inside of the carrier plate supports a number of elongated address electrodes that are likewise arranged parallel to each other. In a color screen the picture elements of the plasma screen are formed in the three basic colors red, blue and green by a phosphor layer on at least part of the carrier plate and/or on the walls of the separating ribs.

The front plate and carrier plate are assembled in such a way that the longitudinal direction of the discharge electrodes has an orthogonal position in relation to the longitudinal direction of the address electrodes. Each of the points of intersection of a pair of discharge electrodes and an address electrode defines a plasma cell, that is a discharge region in the discharge space.

During operation a rectangular alternating voltage (sustaining voltage) of, for example, 100 kHz is applied to all the picture elements. The amplitude is 160 V and is therefore smaller that the igniting voltage. The sustaining voltage and the igniting voltage are dependent upon the distance between and the form of the address and discharge electrodes, the chemical composition and the gas pressure of the gas filling and the characteristics of the dielectric layer that covers the discharge electrodes. If a picture element is to be activated, then a voltage of between 160 V and 180 Volts is applied to the corresponding address and discharge electrodes, that triggers a gas discharge at the points of intersection in the discharge region. A transitory gas discharge develops. The UV radiation that is radiated by the discharge space stimulates the phosphor layer to radiate visible light that appears as a picture element through the front plate. The voltage pulse is also referred to as a write pulse. A short-time current flows until the capacitors have been charged. At the same time a wall charge develops. The wall charging voltage adds to the subsequent negative pulse voltage of 160 V, so that a further discharge is triggered. The capacitance is thus recharged again. This is repeated until the discharge is stopped by an erase pulse. Thus, once active, a picture element lights until it is erased. This is referred to as the memory function of the plasma screen. The erase pulse is so short that a discharge of the capacitances can take place, but not a recharge. Without the wall charging voltage, the voltage is insufficient for ignition when the next pulse comes and the picture element remains dark.

The capacitance of the dielectric layer influences the energy consumption of the plasma screen. If the capacitance of the dielectric layer is high, a high discharge current flows during each discharge and the energy consumption is higher. From U.S. Pat. No. 5,703,437 it is known that the energy consumption of an AC plasma screen of the surface discharge type can be reduced by selecting for the dielectric layer a material that has a low dielectric constant and thus a low capacitance.

A low capacitance of the dielectric layer covering the discharge electrodes, however, requires higher igniting, sustaining and erase voltages, and such higher operating voltages lower the service life of the screen and require more complex control electronics.

The object of the present invention is therefore to fashion a plasma screen of the surface discharge type that is characterized by low energy consumption with higher efficiency and a long service life.

In accordance with the invention this object is achieved by a plasma screen comprising a carrier plate, a front plate, a ribbed structure that partitions the space between the carrier plate and the front plate into plasma cells that are filled with a gas, an electrode array of pairs of discharge electrodes that are arranged in pairs on both sides of the discharge path on the front plate, a dielectric layer of thickness d and dielectric constant ε that covers the electrode array on the front plate, and an electrode array of address electrodes on the carrier plate, with the capacitance C=f(d, ε) of the dielectric layer being varied transversally to the discharge channel.

The idea behind the invention is to provide a plasma screen of the surface discharge type, in which the dielectric layer above the discharge electrodes forms a capacitive input structure that works as a capacitive voltage divider. At locations where the capacitance of the dielectric layer is high, the field lines are concentrated and the ignition voltage reduced. At locations where the capacitance of the dielectric layer is low, the energy density of the discharge is lower and the plasma efficiency is increased. As a result a high plasma efficient and a low reactive power are simultaneously achieved along with a low voltage level and a long service life.

Particularly advantageous effects, compared with the state of the art, are revealed by the invention if the capacitance C of the first dielectric layer has a minimum, that is flanked on either side by a maximum, over a discharge channel.

Such an arrangement benefits the desired transversal discharge structures.

Within the scope of the present invention it is preferred that the capacitance C of the first dielectric layer is varied by means of the layer thickness d.

Dielectric layers are easy to apply in differing layer thicknesses, and therefore are easy to manufacture with a low risk of rejection.

It may also be preferable to vary the capacitance C of the first dielectric layer by means of the dielectric constant ε.

If the capacitance is varied by means of the dielectric constants of the dielectric layer, the surface of the front plate turned towards the plasma can essentially be kept planar.

In a further embodiment of the invention the discharge electrodes can be contacted by bus electrodes of a first and second type, in order to further reduce the ignition voltage for the gas discharge.

In the following the invention is further explained with reference to 7 figures.

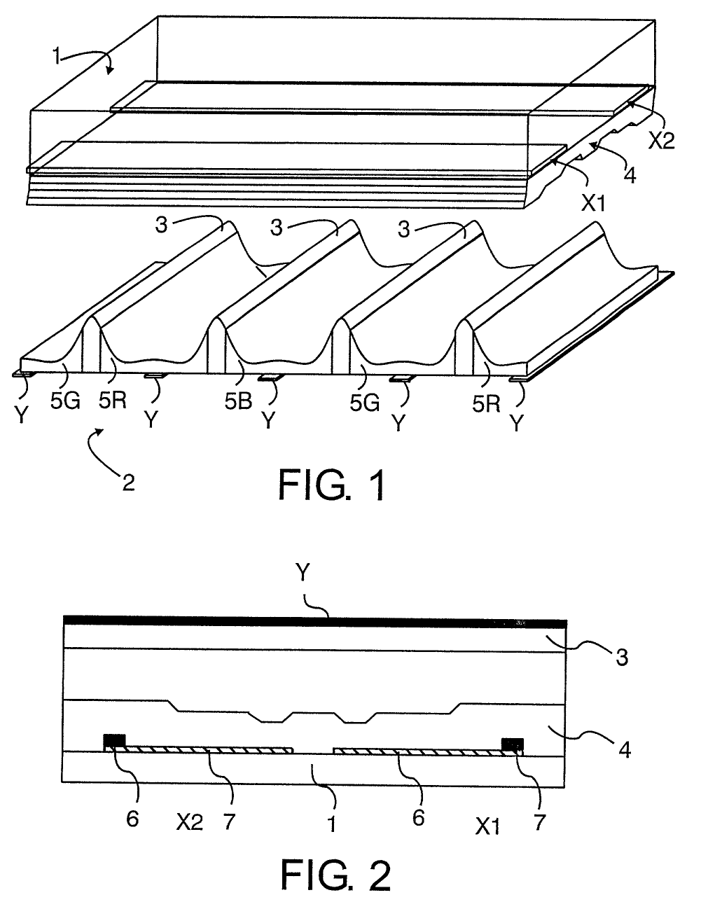

FIG. 1 shows a semi-perspective view of an embodiment of the plasma screen in accordance with the invention with varying layer thickness of the dielectric protective layer.

FIG. 2 shows a cross-section through the embodiment of the plasma screen in accordance with the invention with varying layer thickness of the dielectric protective layer.

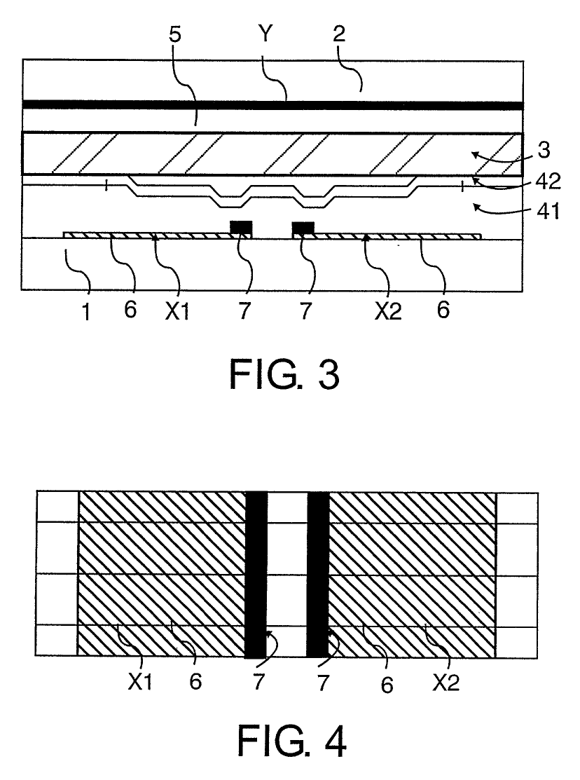

FIG. 3 shows a cross-section through an embodiment of the plasma screen in accordance with the invention with bus electrodes of the second kind.

FIG. 4 shows a plan view of a front plate of an embodiment of the plasma screen in accordance with the invention with bus electrodes turned towards each other.

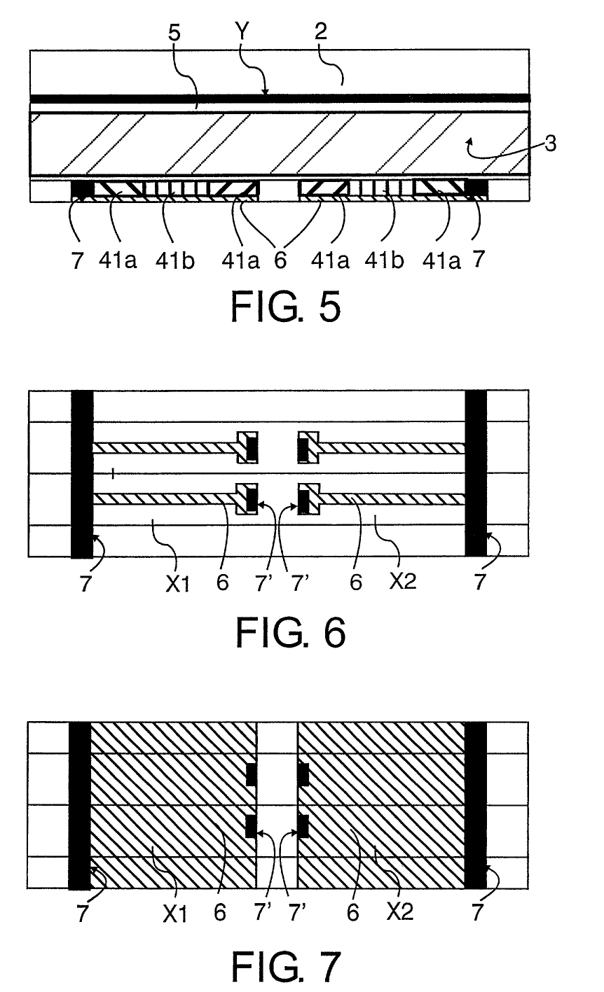

FIG. 5 shows a cross-section through a further embodiment of the plasma screen in accordance with the invention with varying capacitance of the dielectric protective layer.

FIG. 6 shows a plan view of the front plate of an embodiment of the plasma screen in accordance with the invention with structured strip electrodes and bus electrodes of the second type.

FIG. 7 shows a plan view of the front plate of an embodiment of the plasma screen in accordance with the invention with bus electrodes of the first and second type.

A first embodiment of an AC plasma screen of the surface discharge type in accordance with the invention is shown in FIGS. 1 and 2. It is a color screen with a three-electrode configuration. An individual picture element, that is a sub-pixel, is defined by a pair of discharge electrodes X1 and X2 and an address electrode Y. The sub-pixels for each basic color of the color screen are preferably arranged in a line parallel to the address electrodes: three sub-pixels for the three basic colors red, green and blue form a pixel.

Considered in detail the carrier plate comprises in succession a substrate 2 of glass, quartz or a ceramic, an array of electrodes comprising a number of elongated address electrodes Y, that essentially extend parallel to each other on the substrate, phosphor layers 5R, 5B, 5G, that cover the address electrodes, and also separating ribs 3 that form a ribbed structure. The separating ribs of the ribbed structure are arranged between the individual address electrodes so as to run in the same direction as these.

The front plate likewise comprises a substrate 2. Normally this is transparent and consists of glass. The front plate also comprises an array of pairs of elongated strip-shaped discharge electrodes X1, X2, that are formed on the inner surface of the transparent glass substrate. Each pair of discharge electrodes is arranged in pairs and separated by a discharge channel. Each individual discharge electrode preferably comprises a transparent strip electrode 6 and a metal bus electrode 7 that is laminated onto the transparent strip electrode.

The discharge electrodes are each connected to a pole of a high voltage source, so that a high alternating voltage can be applied between neighboring electrodes.

The material of the transparent discharge electrodes customarily is a transparent conductive material, such as Indium Tin Oxide (ITO) or non-stoichiometric tin oxide SnOₓ.

The front plate also comprises a transparent first dielectric layer 4 that covers the electrode pairs. The transparent dielectric layer can have a relatively fine geometric structure of many segments, each segment having a different capacitance. Besides, gradation of an effective layer thickness in discrete steps or as a continuous process by varying the thickness of the dielectric layer or by varying the surface portions of the dielectric materials can take place. It is preferable for the capacitance to be continuously varied so that the desired discharge structure can be formed.

In accordance with a first embodiment of the invention the discharge electrodes, as shown in FIGS. 1 and 2, are coated with a layer of dielectric material, and the thickness of the dielectric layer is varied. This layer is made thicker between the two discharge electrodes. It tapers symmetrically towards the outside and further outwards increases in thickness again.

As a result, in the area of the taper an area of high electrical field strength is generated, in which the electrons are accelerated.

Suitable materials for the dielectric layer, for the high-voltage, puncture-proof, electrically insulating materials (dielectrics) are by way of example borosilicate glass, quartz glass, fritted glass, Al₂O₃, MgF₂, LiF and BaTiO₃. The choice of dielectric materials is not, however, restricted to these materials. Other dielectric materials with paraelectric, ferroelectric and anitferroelectric characteristics can equally be used.

For the dielectric layers, apart from MgO, also CeO₂, Ce0₂ and La₂O₃, quartz, borosilicate glass, leaded glass, SiO₂, Al₂O₃, alkaline earth metal titanates, alkaline earth oxides such as CaO, SrO and fluorides such as LiF, MgF₂ and KCl are possible. MgO in particular brings about a low ignition voltage.

The dielectric can comprise one or more layers.

To manufacture this dielectric layer use can be made of the known thick film techniques. For this purpose a dielectric paste is printed, sprayed or rolled onto the glass substrate and then sintered.

The dielectric layer is also coated with a layer of magnesium oxide or another material with a low work function that facilitates the emission of electrons from the substrate.

The discharge electrodes can, in addition to the strip electrodes 6, also comprise bus electrodes of a first type 7 for contacting, in order to reduce the electrical resistance value of the discharge electrodes. For example they can be partly coated with a metal film as the bus. The bus electrodes of the first type can be made from thin chromium/copper/chromium layers or aluminum films or from a thick layer of silver.

The metallic bus electrodes of the first type are arranged in the embodiment in accordance with FIGS. 1 and 2 at the lateral periphery of the transparent strip electrodes on the side opposite the discharge channel.

An embodiment of a plasma screen in accordance with the invention that can be readily manufactured is shown in FIGS. 3 and 4. There the bus electrodes of the first type are not provided on the edge of the discharge electrodes facing away from the discharge path, but on the edge facing the discharge channel. In this way in the ignition area a higher voltage drop over the gas takes place.

In a second embodiment of the invention, transversally to the discharge channel, a series of layer segments is arranged, the materials of which have differing dielectric constants. A preferred arrangement is as shown in FIG. 5 in which the layer segments 41a, 41b are arranged symmetrically with respect to the discharge channel.

A particularly preferred arrangement is one with a minimum capacitance below the discharge channel, bordered on both sides below the electrodes by layer segments with maximum capacitance. Where the capacitance is high and the drop in potential in the dielectric layer is low, a higher drop in potential takes place from the electrode to the gas area across the dielectric layer. Where the drop in potential is already high in the dielectric layer, the drop in potential to the discharge area is lower.

The potential in the gas discharge area can also be affected by the position, mutual alignment and form of the electrodes.

Normally the discharge electrodes are in the form of strips of uniform width. The potential across the discharge path can, however, be further supported by division of the electrodes. For this purpose the pairs of discharge electrodes alternately comprise areas of different width, within which the discharge is initiated or suppressed.

By way of example FIG. 6 shows an embodiment of the discharge electrodes in which the strip electrodes are comb electrodes with comb-like slits and T-shaped teeth. The T-shaped teeth extend transversally in the longitudinal direction of the electrodes such that the teeth of neighboring comb electrodes lie opposite each other at the same level and delimit the discharge channel.

The comb-like slits are repeated at regular intervals, the width of which corresponds to a picture element. The electrodes are then arranged in such a way that they each have two identical areas facing each other. In this way diagonal discharge structures are suppressed, and the discharge rather burns directly towards the next neighboring area of the counter-electrode.

In a further embodiment of the invention the discharge electrodes can, apart from the known bus electrodes of the first type, also comprise bus electrodes of the second type 7′.

FIG. 5 shows an embodiment of the invention in which, on a comb electrode with T-shaped teeth, the T-bars are covered with island-shaped bus electrodes of the second type 7′.

In accordance with FIG. 7 such island-shaped bus electrodes of the second type 7′ can also be placed on unsegemented strip electrodes along the discharge channel. These island-shaped bus electrodes of the second type have the advantage that they initiate the ignition of the gas discharge centrally in the discharge channel, enabling losses through plasma-wall interactions to be reduced.

1. Plasma screen comprising a carrier plate, a front plate, a ribbed structure that partitions the space between the carrier plate and the front plate into plasma cells that are filled with a gas, an electrode array of pairs of discharge electrodes that are arranged in pairs on both sides of a discharge channel on the front plate, a first dielectric layer of thickness d and dielectric constant ε that covers the electrode array of pairs of discharge electrodes on the front plate, and an electrode array of address electrodes on the carrier plate, with the capacitance C=f(d, ε) of the first dielectric layer being varied transversally to the discharge channel.

2. Plasma screen as claimed in claim 1, characterized in that the capacitance C of the first dielectric layer over a discharge channel has a minimum that is flanked on both sides by a maximum.

3. Plasma screen as claimed in claim 1, characterized in that the capacitance C of the first dielectric layer is varied by means of the layer thickness d.

4. Plasma screen as claimed in claim 1, characterized in that the capacitance C of the first dielectric layer is varied by means of the dielectric constant ε.

5. Plasma screen as claimed in claim 1, characterized in that the discharge electrodes are contacted by bus electrodes of a first and second type.
